(19) United States
(12) Patent Application Publication
(10) Pub. No.: US 2010/0139320 A1
(43) Pub. Date: Jun. 10, 2010

(54) Hollow porous-wall glass microspheres and composition and process for controlling pore size and pore volume

(75) Inventors: Ray F. Schumacher, Aiken, SC (US); David K. Peeler, Evans, GA (US); Erich K. Hansen, Aiken, SC (US); George G. Wicks, Aiken, SC (US); Leung K. Heung, Aiken, SC (US)

Correspondence Address: J. BENNETT MULLINAX, LLC, P. O. BOX 26029, GREENVILLE, SC, 29616-1029, US

(73) Assignee: Savannah River Nulcear Solutions, LLC, Aiken, SC (US)

(21) Appl. No.: 12/315,544

(22) Filed: Dec. 4, 2008

(51) Int. Cl. C03B 19/10

(52) U.S. Cl. 65/21.4

(57) ABSTRACT

A porous wall hollow glass microsphere is provided having a diameter range of between 1 to 200 microns, a density of between 1.0 to 2.0 gm/cc, a porous-wall structure having wall openings defining an average pore size of between 10 to 1000 angstroms, and which contains therein a hydrogen storage material. The porous-wall structure may be modified by precise control of heat treatment temperatures of precursor hollow glass microspheres such that the pore diameter and percentage of pore formation may be regulated. The ability to control characteristics of porosity allow customization of specific applications for the PWHGM in a variety of biomedical, sensor, hydrogen storage, and other microencapsulation technologies.

### STATEMENT AS TO RIGHTS TO INVENTIONS MADE UNDER FEDERALLY SPONSORED RESEARCH AND DEVELOPMENT

This invention was made with Government support under Contract No.

DE-AC0996-SR18500 awarded by the United States Department of Energy. The Government has certain rights in the invention.

### FIELD OF THE INVENTION

This invention is directed towards porous wall hollow wall glass microspheres (PWHGM) and a process of controlling the pore size and pore volume of the PWHGM. The PWHGM defines a series of pores. The pores facilitate the placement of a substrate within the interior of the hollow glass microsphere or within the pores themselves. The porosity of the hollow glass microspheres can be regulated by selection of the glass used to create the PWHGM and the selective use of heat treatment. In this manner, it has been found that the pore size and pore volume within the wall may be varied to suit tailored applications so as to accommodate different additives such as hydrogen storage materials, catalysts, or other agents.

The controlled pore size, for example, enables the selective absorption of hydrogen gas through the walls of the hollow glass microsphere while isolating a hydrogen storage material encapsulated therein from other external gases and fluids. The hollow glass microspheres can thereafter be subjected to variations in temperature, pressure, or other release stimulus triggers to bring about the release of hydrogen gas. Once dehydrided, the hollow glass microspheres and hydrogen storage material can be reused so as to once again selectively absorb hydrogen gas.

However, the invention is not restricted to hydrogen storage materials in that a variety of catalysts and reactive materials may be introduced into the hollow interior of the PWHGM or placed within the pores defined in the wall of the PWHGM. For instance, useful applications include molecular sieves, drug and bioactive delivery systems, as well as chemical and biological indicators and sensors where a desired reagent may be incorporated into at least one of the pores and/or hollow interior of the PWHGM.

### BACKGROUND OF THE INVENTION

The formation of hollow glass microspheres (HGMs) is well known in the art. The production of hollow glass microspheres has been described in U.S. Pat. No. 3,365,315 (Beck); U.S. Pat. No. 4,661,137 (Garnier); and U.S. Pat. No. 5,256,180 (Garnier), and which are incorporated herein by reference.

It is also known in the art to produce large macrospheres having hollow glass walls which provide a semipermeable liquid separation medium for containing absorbents. The production of macrosphere structures can be seen in reference to U.S. Pat. Nos. 5,397,759 and 5,225,123 to Torobin and which are incorporated herein by reference. The Torobin references disclose hollow glass macrospheres comprising multiple particle glass walls. The reference teaches the use of the macrospheres for gas/liquid separation and for use with absorbents but does not discuss any features or characteristics which would make the macrospheres suitable as a hydrogen storage medium.

U.S. Pat. No. 4,842,620 (PPG Industries) is directed to non-crystalline silica fibers having porous walls which are used in gas separation. The fibers described in this application have different physical characteristics than microspheres and which makes fibers less desirable with respect to hydrogen separation and storage capabilities.

U.S. Pat. No. 6,358,532 (CaP Biotechnology, Inc.) uses porous-wall hollow glass microspheres for cell clustering and biomedical uses. The porous-wall structures are designed to readily release microsphere contents when present within a biotic system. Alternatively, the microspheres are used to provide a substrate to support cell growth within the porous-wall structure.

While the above references disclose a variety of glass microspheres and porous-wall structures having various uses in material separation or drug delivery capabilities, there remains room for improvement and variation within the art.

### SUMMARY OF THE INVENTION

It is at least one aspect of at least one embodiment of the present invention to provide for a porous wall hollow glass microsphere (PWHGM) having a diameter range of between about 1.0 micron to about 200 microns, a density of about 1.0 gm/cc to about 2.0 gm/cc, and having a porous-wall structure having wall openings with an average pore size of between about 10 angstroms to about 1000 angstroms. In accordance with this invention, it has been found that for a given glass particulate material used to manufacture PWHGMs, a heat treatment step prior to extracting an acid soluble component from the walls of a hollow glass microsphere can bring about controlled changes to the pore size and pore volume. Further, even slight temperature differences in the heat treatment step have been found to bring about significant changes in the resulting pore characteristics of the PWHGMs.

It is at least one aspect of at least one embodiment of the present invention to provide for a porous wall hollow glass microsphere (PWHGM) having a diameter range of between about 1.0 to about 200 microns, a density of about 1.0 gm/cc to about 2.0 gm/cc, and having a porous-wall structure having wall openings with an average pore size which may range from about 10 to about 1000 angstroms, the pore size and pore volume being regulated by a heat treatment step which occurs following formation of a hollow glass microsphere and prior to an extraction of a soluble phase component of the hollow glass microsphere.

It is yet a further and more particular aspect of at least one embodiment of this invention to provide for a process of making a PWHGM comprising the steps of mixing glass forming chemicals together which are melted to form a glass which is phase separable into two glass phases. Thereafter, the phase separable glass is formed into particulates having a size range of between about 10 to about 50 μm of glass composition with a latent blowing agent thereby providing a mixture of glass particles; increasing the temperature and viscosity of the individual particles wherein the latent glass blowing agent forms a single glass bubble within the interior of the particulate, the particulate further forming a sphere; increasing the temperature of the sphere, the gas bubble expanding the sphere into a hollow glass microsphere; heat treating the hollow glass microsphere to a temperature of between about 580° C. to about 600° C. thereby forming a silica rich continuous glass phase and an extractable continuous glass phase of the hollow glass microsphere; and removing the extractable continuous glass phase, thereby providing a porous-wall hollow glass microsphere.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawing.

FIG. 1 is a cross sectional view of a hollow glass porous-wall microsphere containing a hydrogen storage material within the interior of the microsphere.

FIG. 2 is a scanning electron micrograph of a PWHGM that was heat treated at 600° C. for 8 hours prior to acid leaching.

FIG. 3 is a scanning electron micrograph of a PWHGM that was heat treated at 580° C. for 8 hours prior to acid leaching.

FIG. 4 is a porosity graph setting forth changes of various heat treatment conditions of wall porosity.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

The porous wall hollow glass microspheres of the present invention are prepared using a special glass composition to form hollow glass microspheres which after appropriate heat treatment separate into two continuous glass phases. In the examples provided herein, one of the phases is rich in silica, while the other is an extractable phase. The extractable phase is preferably present in an amount of at least about 30 weight percent of the total glass composition. However, other porous glass compositions may be used.

The extractable phase of the glass composition preferably includes boron-containing materials such as borosilicates or alkali-metal borosilicates. Suitable borosilicates and alkali-metal silicates may be found in reference to the teachings of U.S. Pat. No. 4,842,620 directed to leachable glass fiber compositions and which is incorporated herein by reference.

The extractable and non-extractable glass components identified in Table 1 were prepared using reagent-grade metal oxides, carbonates, H₃BO₃, and salts to yield approximately 600 gms of glass using standard batching and melting procedures. The glass component raw materials were thoroughly mixed and placed into crucibles which were heated in a furnace from room temperature to 1300° C. in a linear temperature progression. Following an isothermal hold at 1300° C. from 1 to 3 hours, the crucibles were removed from the furnace and the glasses were poured onto clean stainless steel plates and allowed to air cool. Following cooling, the glasses were crushed, placed in a crucible and remelted at 1300° C. for 1 hour in order to increase the homogeneity of the final glass. Following the final melt, the glass was poured onto a clean stainless steel plate and allowed to air cool.

Following cooling, the glass was reduced to a granular size using a hammer and stainless steel plate. The granular glass material was either placed in a mechanical grinder for 10 minutes or a ball mill with alumina media for several hours to form a glass powder. The resulting glass powder was sieved through two different sized sieves of 63 μm and 44 μm mesh screens. The materials passing through the 44 μm screen were further processed by removing fine particles less than 10 μm using a series of decantations in water. Optionally a surfactant may be added to the water to improve dispersion. The final feed material, consisting of fine particulates ranging from 10 to 44 μms, was separated from the decantation liquid and dried overnight at 90 to 95° C. The resulting 10 to 44 μm glass powder was used as the feed material for hollow glass microspheres (HGM) production.

The glass powder feed material was fed into a flame forming process as described in assignee's co-pending applications having Ser. No. 11/256,442 filed on Oct. 21, 2005 and PCT/US2006/046167 filed on Dec. 4, 2006, the above referenced applications being incorporated herein by reference in their entirety.

As described in the above references, a gas flame is used to raise the temperature of the glass particles where a latent blowing agent within the glass causes a single bubble to nucleate within each particle of glass. As the glass particle temperature increases by exposure to the flame, the glass particle reaches a viscosity where the particle transforms to a sphere due to the surface tension forces. As the temperature increases, the pressure within the bubble exceeds the surface tension/viscous forces value and the bubble expands to form a hollow glass microsphere. The hollow glass microsphere is then rapidly quenched with water to room temperature and collected in containers along with the quench water.

The resulting hollow glass microspheres have densities in the range of about 0.10 gm/cc to about 0.5 gm/cc and diameters may range between about 1 to about 200 microns. Once formed, the hollow glass microspheres may be separated on the basis of density so as to select and segregate the hollow glass microspheres according to desired densities. Additionally, it is possible to separate the non-porous HGMs according to the microsphere diameter.

The resulting hollow glass microspheres have a glass wall composition in which the glass is essentially homogeneous. The hollow glass microspheres are then heat treated at a temperature of about 580° C. to about 600° C. to enhance the glass-in-glass phase separation by mixing the hollow glass microspheres with carbonaceous materials and heating in the absence of oxygen to the desired temperature region. The effect of temperature was separately evaluated by treating one sample of hollow glass microspheres at 580° C. and a second batch at 600° C. for various time intervals ranging from intervals of 8 hours to 24 hours. The process of heat treating the hollow glass microspheres allows the glass to separate into two continuous glass phases: one extractable and the other rich in silica. The extractable phase is readily leachable using strong mineral acids which results in the formation of wall pores within the remaining silica-rich phase. Suitable mineral acids and methods for leaching the glass may be seen in reference to U.S. Pat. No. 4,842,620 which is incorporated herein by reference.

The resulting hollow glass microspheres exhibit a high degree of cell wall porosity. As used herein, the term “porosity” means a series of pores and similar openings which either directly or indirectly define a series of passageways which provide communication between the interior and the exterior of the hollow glass microsphere. An average cell wall pore size of about 10 angstroms to about 1000 angstroms can be achieved using this technology. The cell wall pore size and porosity is dependent upon the percentage of extractable components formulated into the special glass composition used in the formation of the PWHGM and the degree of heat treatment employed. Surprisingly, as set forth below, it was found that even slight temperature differences between various heat treatment steps can result in significant differences in the porosity characteristics of the PWHGM.

It has been noted that there is a marked increase in yield of PWHGM when the HGMs are heat treated prior to acid leaching. It has been found that using an 8 to 24 hour heat treatment, compared to no heat treatment, results in a coarsening of the microstructure such that a larger fraction of the highly soluble, silica-pore phase is available for removal through acid leaching. Accordingly, a higher fraction of the hollow glass wall material is leached during the acid treatment and a greater percentage of PWHGMs are formed.

Using electron microscopy and mercury porosimetry data, it was observed that the average pore size of non-heat treated samples was approximately 100 angstroms. In comparison, heat treated samples had an average pore size of approximately 1000 angstroms, a 10 fold increase.

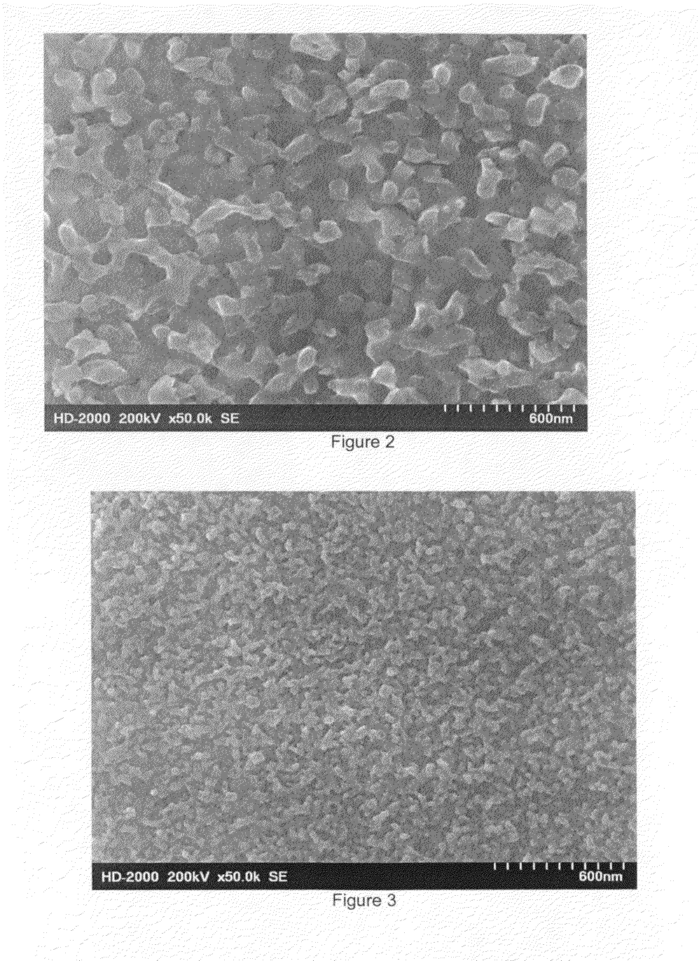

Additionally, it was observed that increasing the heat treatment time for any fixed temperature from 8 hours to 24 hours resulted in very little change in the pore microstructure. Surprisingly, more significant results were noted comparing heat treatment temperatures between 580° C. and 600° C. As seen in reference to FIG. 2 and FIG. 3, the 20° C. change in heat treatment temperature results in significant differences in pore microstructure. In general, the degree of phase separation and resulting porosity increases substantially by the 20° C. increase in heat treatment temperature.

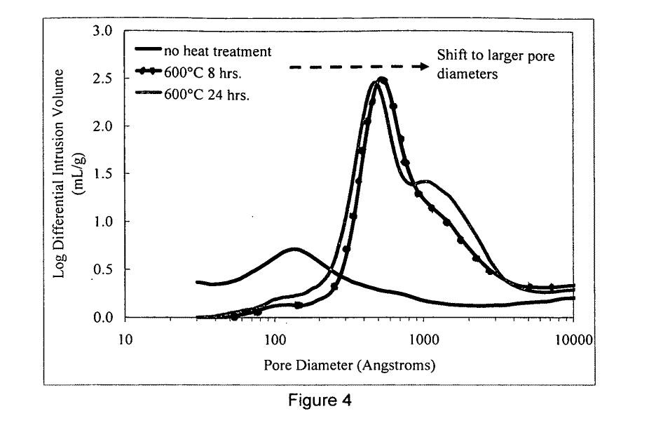

As set forth in FIG. 4, mercury porosimetry measurements reflecting differences between a 580° C. heat treatment and a 600° C. heat treatment indicates that the 20° increase in temperature can bring about a substantial increase in overall pore volume. The increase in pore volume can bring about meaningful improvements for applications where the pores themselves are used as a location for a desired reagent. Increasing overall porosity may also influence an effective pore diameter with respect to communication between an exterior of the PWHGM and an interior of the PWHGM. By controlling effective pore diameter, the PWHGM can effectively be used as a size limiting filter so as to exclude on the basis of size passage of materials from an exterior to the interior of the PWHGM.

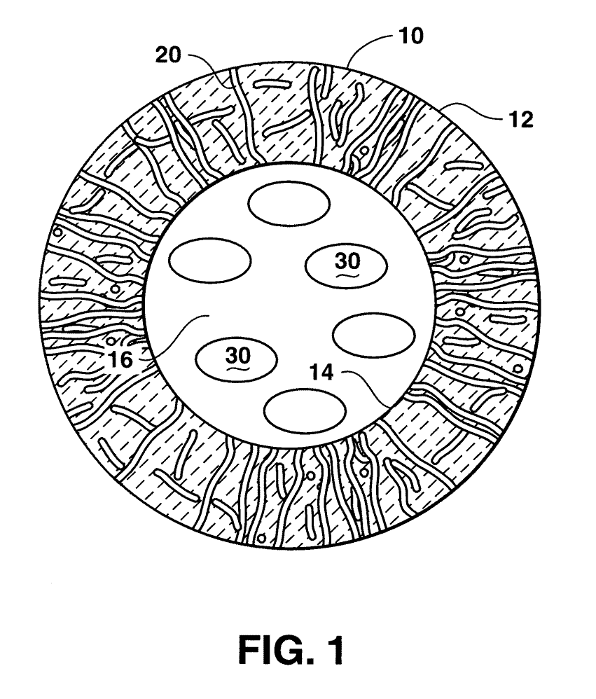

As seen in reference to FIG. 1, a cross section through a PWHGM 10 is provided. Microsphere 10 comprises a glass wall having an exterior surface 12 and an interior surface 14. The microsphere 10 further defines a hollow cavity 16 within the interior of the microsphere. As best seen in reference to the Figure, a plurality of pores 20 are defined within the glass wall of the microsphere. As illustrated in FIG. 1, a number of the pores 20 provide for communication between an exterior of the PWHGMs and the interior cavity 16 of the PWHGMs. Present within the hollow cavity 16 is a material 30 which may be a pharmacological agent, a hydrogen storage material, a catalyst, or other desired chemical or biological material. The placement of the hydrogen storage material within the cavity 16 is provided in greater detail below.

TABLE 1
GLASS COMPOSITION

| | | | Unleached | | | |
|---|---|---|---|---|---|---|
| | | | HGMs | | PWHGMs | |
| Glass | | | (Chemical | | (Chemical | |
| Powder | (Calculated) | | Analysis) | | Analysis) | |
| SiO2 | 59.85 | wt % | 70.2 | wt % | 88.25 | wt % |
| B2O3 | 22.11 | | 16.3 | | 04.91 | |
| CaO | 06.09 | | 08.08 | | 01.66 | |
| F | 02.03 | | ND | | ND | |
| ZnO | 01.78 | | 01.64 | | 00.36 | |
| Na2O | 03.9 | | 02.51 | | 00.69 | |
| P2O5 | 00.77 | | ND | | ND | |
| SO3 | 01.25 | | ND | | ND | |
| Li2O | 03.0 | | 02.32 | | 00.54 | |
| Total | 100.78 | | 101.05 | | 96.4 | |

Following the leaching process, the PWHGM cell wall contains small interconnected pores predominantly in the range of about 10 to about 1000 Angstroms and which pass completely through the PWHGM wall.

It was further observed that following the leaching process, PWHGMs exhibited a weight loss of approximately 33% which is again indicative of the formation of pores through the selective removal of the alkali borate phase. Further, using a gas pycnometer, the density of the glass microspheres changes from about 0.35 g/cc (unleached) to a density of about 1.62 g/cc for the leached PWHGMs. The increase in density is further indicative that the alkali borate material has been selectively removed and that openings exist for the gas to enter the interior of the PWHGMs causing the increase in density. It is noted that the density of fused silica is about 2.2 g/cc. It is believed that the PWHGM density following extraction approaches the value of fused silica, but the lower density is indicative that a small percentage of PWHGMs are not porous or that during the drying process a gel film may have formed over some of the pores and/or not all of the alkali borate phase was extracted during the heated acid treatment.

The PWHGMs made according to Example 1 above were compared to commercially obtained non-porous hollow glass microspheres for determination of total surface area. Using gas absorption techniques, it was demonstrated that the surface area of the non-porous commercial samples was approximately 1 square meter/gram. The surface area of the PWHGMs made according to the present invention was 29.11 square meter/gram. The increased surface area of the PWHGMs indicates a significant increase in surface area reflective of the formation of pores. It is noted that if the PWHGMs simply had holes present within the walls, the surface area would merely include the interior and exterior surfaces for an expected value of approximately 2 square meters/gram. Additional analysis of the PWHGMs using gas absorption/deabsorption indicated an average pore size of about 553 Angstroms.

For certain applications, it is noted that by additional heating of the PWHGMs to a temperature of about 1000° C., the porosity can be removed and/or selectively reduced by controlling the temperature and treatment time intervals. It is believed advantageous for application to subsequently remove or reduce the porosity once a desired material is inserted into the interior of the PWHGM. By removing the pores and/or substantially reducing the size of the pores, the material placed within the interior of the pores and/or the PWHGM interior is protected from larger molecule reactants that could render the material inactive.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole or in part. Therefore, the spirit and scope of the appended claims should not be limited to the description of the preferred versions contained therein.

That which is claimed:

1. The process of making a hydrogen storage apparatus comprising the steps of:
mixing glass forming chemicals to form a glass which is phase separable into two glass phases;
forming said phase separable glass into particulates having a size range of between about 10 to about 50 μm of glass composition;
mixing said particulates with a latent blowing agent thereby providing a mixture of individual glass particles;
increasing the temperature and viscosity of said individual particles wherein said latent glass blowing agent forms a single glass bubble with an interior of said particulate, said particulate further forming a sphere;
increasing said temperature of said sphere, said gas bubble expanding said sphere into a hollow glass microsphere;
heat treating said hollow glass microsphere to a temperature of between about 580° C. to about 600° C. thereby forming a silica rich continuous glass phase and an extractable continuous glass phase of said hollow glass microsphere; and,
removing said extractable continuous glass phase, thereby providing a porous-wall hollow glass microsphere.
